(19) United States
(12) Patent Application Publication
(10) Pub. No.: US 2015/0000386 A1
(43) Pub. Date: Jan. 1, 2015

(54) AUTOMATIC SAMPLE POURING DEVICE

(71) Applicant: SHIMADZU CORPORATION, Kyoto-shi, Kyoto (JP)

(72) Inventor: Hiroyuki Minato, Kyoto-shi (JP)

(73) Assignee: SHIMADZU CORPORATION, Kyoto-shi, Kyoto (JP)

(21) Appl. No.: 14/375,517

(22) PCT Filed: Dec. 21, 2012
(86) PCT No.: PCT/JP2012/083354

§ 371 Date: Jul. 30, 2014

(30) Foreign Application Priority Data
Feb. 15, 2012 (JP) 2012-030155

(51) Int. Cl. G01N 1/00; G01N 35/10; G01N 30/00

(52) U.S. Cl. CPC G01N 1/00; G01N 30/00; G01N 35/10; G01N 2001/002
USPC 73/64.56

(57) ABSTRACT

An automatic sample pouring device comprising a rack, a sampling needle, a reference portion arranged at a predetermined position of the rack, a detection unit for electrically detecting contact between the reference portion and the needle, and a control unit for controlling an operation of relatively moving the needle on a horizontal plane and in a vertical direction with respect to the rack, and suctioning and pouring operations of a sample. The control unit is configured to control an operation of obtaining reference position information of the rack on the basis of detection information of the detection unit.

### TECHNICAL FIELD

The present invention relates to an automatic sample pouring device.

### BACKGROUND ART

In a liquid chromatograph, an ion chromatograph, and the like, an automatic sample pouring device for automatically suctioning samples contained in respective sample containers is used. The automatic sample pouring device inserts a sampling needle into a needle insertion position of a sample container to thereby suction a sample from the sample container. At this time, to accurately grasp the needle insertion position of the sample container, correction information for insertion position information set in advance has to be acquired by adjustment in advance.

Further, normally, a plurality of sample containers are laid out on a plate-shaped portion called a rack. The rack is arranged at a rack arrangement position of the automatic sample pouring device. Information about a positional relationship between a reference position provided on the rack and a needle is acquired. Correction information for the needle insertion position of every sample container on the rack is acquired on the basis of the information about the positional relationship.

### PRIOR ART DOCUMENT

### Patent Document

Patent Document 1: Japanese Patent Laid-open Publication No. 2000-146775

### SUMMARY OF THE INVENTION

### Problems to be Solved by the Invention

With the automatic sample pouring device, adjustment for acquiring correction information for the needle insertion position is performed by the procedure of arranging the rack at the automatic sample pouring device, manually operating and finely moving a needle to a reference position point above the rack, and storing, in the automatic sample pouring device, position information at the time of the needle tip reaching a reference position (for example, see Patent Document 1).

There are problems that, in order to acquire the reference position on the rack, an operator has to finely operate the automatic sample pouring device, and that the number of steps is great.

The present invention has its object to provide an automatic sample pouring device capable of automatically obtaining reference position information of a rack.

### Solutions to the Problems

An automatic sample pouring device according to the present invention includes a rack allowing mounting of a plurality of sample containers, a sampling needle for suctioning samples contained in the sample containers, a control unit for controlling an operation of relatively moving the needle on a horizontal plane and in a vertical direction with respect to the rack, and suctioning and pouring operations of a sample, a reference portion, arranged at a predetermined position of the rack, including a concave portion of a predetermined depth, a shape of an inner wall surface of the reference portion in horizontal cross section being point-symmetric, and a detection unit for electrically detecting contact between the reference portion and the needle. After moving a tip end of the needle into the reference portion, the control unit moves, until contact between the reference portion and the needle is detected on the basis of detection information of the detection unit, the needle in both positive and negative directions in an X direction on the horizontal plane, both positive and negative directions in a Y direction that is orthogonal to the X direction on the horizontal plane, and a Z direction that is the vertical direction, calculates, on the basis of a contact position of the reference portion and the needle, a position at a center of symmetry of the shape of the inner wall surface of the reference portion as an X position and a Y position of the reference portion, and takes a position of a bottom surface of the reference portion as a Z position of the reference portion, and obtains reference position information of the rack on the basis of the X position, the Y position, and the Z position of the reference portion.

According to the automatic sample pouring device of the present invention, the order of movement of the needle in each direction of the X direction, the Y direction, and the Z direction for obtaining the reference position information of the rack is arbitrary. Moreover, the order of calculation of the X position of the reference portion, calculation of the Y position of the reference portion, and calculation of the Z position of the reference portion is also arbitrary.

According to the automatic sample pouring device of the present invention, the rack may include two or more of the reference portions at mutually different positions, and the control unit may calculate the X position, the Y position, and the Z position of the reference portion for each of a plurality of the reference portions. However, the rack may also be structured so as to include only one reference portion.

Further, an example may be cited where the control unit calculates the X position or the Y position of the reference portion by moving the needle in the X direction or the Y direction inside the reference portion, calculates, by moving the needle in the Y direction or the X direction from the X position or the Y position which has been obtained, the Y position or the X position of the reference portion, calculates again, by moving the needle again in the X direction or the Y direction from the Y position or the X position which has been obtained, the X position or the Y position of the reference portion, and calculates again, by moving the needle again in the Y direction or the X direction from the X position or the Y position which has been obtained again, the Y position or the X position of the reference portion.

Incidentally, it is also possible that calculation of the X position of the reference portion and calculation of the Y position of the reference portion are each performed only once. Also, calculation of the X position of the reference portion and calculation of the Y position of the reference portion may be performed mutually different number of times. Furthermore, calculation of the X position of the reference portion and calculation of the Y position of the reference portion may each be performed three times. Additionally, in the case at least calculation of the X position of the reference portion or calculation of the Y position of the reference portion is to be performed several times, calculation of the X position and calculation of the Y position are performed alternately.

Furthermore, the reference portion may include a through hole for draining liquid at a position at a predetermined distance from a center of the bottom surface, or at a side surface.

Moreover, an example may be cited where the reference portion is arranged in an attachable/detachable manner at a mounting position of the sample container of the rack. However, the reference portion may alternatively be arranged at a position different from the mounting position of the sample container in a fixed or attachable/detachable manner.

### Effects of the Invention

The automatic sample pouring device of the present invention uses a reference portion which is arranged at a predetermined position of a rack, which includes a concave portion of a predetermined depth, and whose inner wall surface shape in horizontal cross section is point-symmetric, moves a tip end of a needle inside the reference portion under the control of a control unit, calculates, on the basis of information about the contact position of the needle and the reference portion at this time, the position at the center of symmetry of the shape of the inner wall surface of the reference portion as an X position and a Y position of the reference portion, and takes the position of a bottom surface of the reference portion as a Z position, and obtains reference position information of the rack on the basis of the X position, the Y position, and the Z position of the reference portion. In this manner, the automatic sample pouring device of the present invention may automatically obtain the reference position information of the rack.

### BRIEF DESCRIPTION OF THE DRAWINGS

FIG. 1 is a diagram schematically showing a structure of an embodiment.

FIG. 2 is a diagram showing a rack used in the present embodiment.

FIG. 3 is a diagram showing a reference portion arranged at the rack.

FIG. 4 is a diagram for describing an operation of a needle at the time of acquiring reference position information of the rack.

FIG. 5 is a diagram showing another example of the reference portion arranged at the rack.

FIG. 6 is a diagram showing further another example of the reference portion arranged at the rack.

FIG. 7 is a diagram showing an example of a position of a through hole for draining liquid in a case where the through hole is provided to a reference portion arranged at the rack.

### EMBODIMENTS OF THE INVENTION

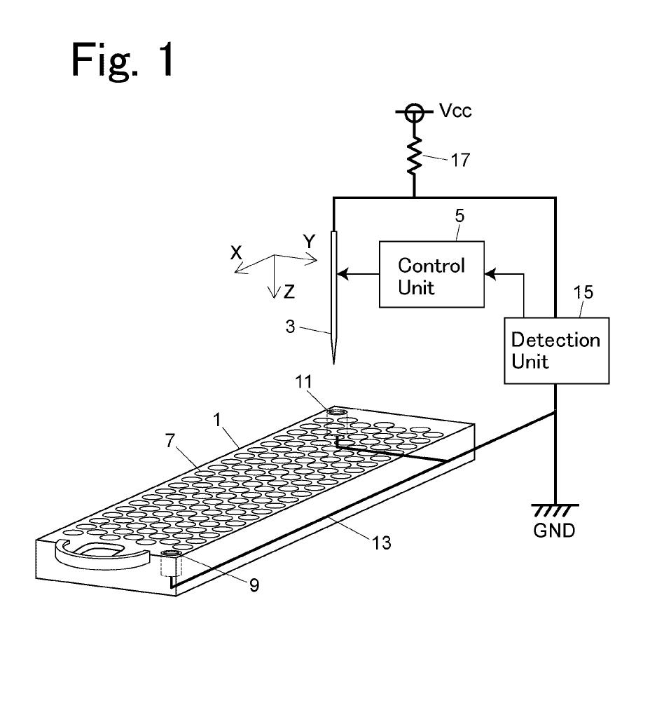

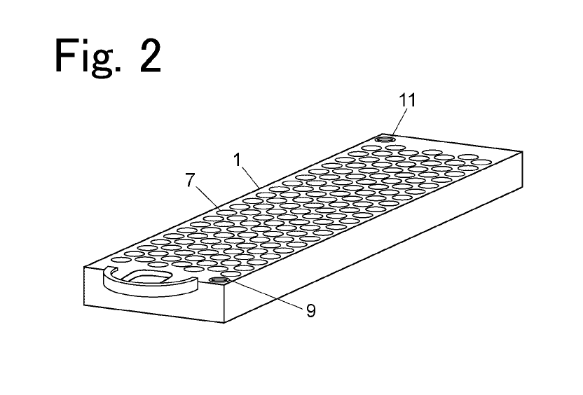

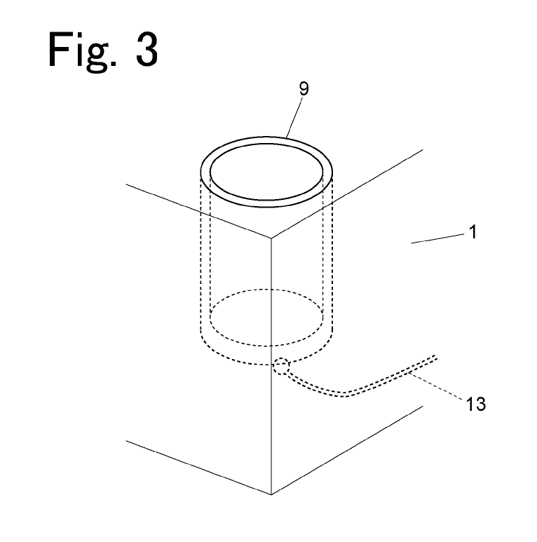

FIG. 1 is a diagram schematically showing a structure of an embodiment. FIG. 2 is a diagram showing a rack used in the present embodiment. FIG. 3 is a diagram showing a reference portion arranged at the rack.

In FIG. 1, a rack 1 on which a plurality of sample containers may be mounted is arranged in an automatic sample pouring device. The rack 1 is installed in the automatic sample pouring device in an attachable/detachable manner by a clamp mechanism (not shown).

A sampling needle 3 for suctioning a sample contained in a sample container (not shown) mounted on the rack 1 in an attachable/detachable manner is arranged above the rack 1. At least the surface of the needle 3 is formed of conductive material.

A control unit 5 for moving the needle 3 on the horizontal plane (X direction and Y direction) and in a vertical direction (Z direction) with respect to the rack 1 by an operation of a needle movement mechanism (not shown) is provided. The control unit 5 also controls suctioning and pouring operations of a sample.

Movements of the needle 3 in the X direction, the Y direction, and the Z direction are each performed with a stepper motor (not shown) as a drive source. Also, these stepper motors are controlled by the control unit 5. This control is normally automatic control by a program, but manual operation through a keyboard or the like is also possible as needed. Movement of the needle 3 is controlled by specifying a position of a movement destination on three-dimensional coordinates of X, Y, and Z.

As shown in FIG. 2, the rack 1 includes, on the board surface, a large number of sample container mounting holes 7 for mounting sample containers. The sample container mounting holes 7 are accurately aligned at regular intervals. The rack 1 includes reference portions 9 and 11 at positions different from the sample container mounting holes 7.

The reference portions 9 and 11 are arranged near two diagonal corners of the rack 1, one near each corner. At least the inner wall surfaces and the bottom surfaces of the reference portions 9 and 11 are formed of conductive material. The reference portions 9 and 11 include concave portions of a predetermined depth. The shape of the inner wall surfaces of the reference portions 9 and 11 is circular (point-symmetric) in horizontal cross section.

As shown in FIG. 1, a conductive wire 13 is connected to the reference portions 9 and 11, the conductive wire being electrically connected to the inner wall surfaces and the bottom surfaces. The conductive wire 13 is connected to a ground potential GND when the rack 1 is installed in the automatic sample pouring device.

A detection unit 15 for electrically detecting contact between the needle 3 and the reference portions 9 and 11 is provided. The detection unit 15 is configured from for example a voltmeter. The positive terminal of the detection unit 15 and the sampling needle are connected to a power source potential Vcc via a pull-up resistor 17. The negative terminal of the detection unit 15 is connected to the conductive wire 13 and the ground potential GND.

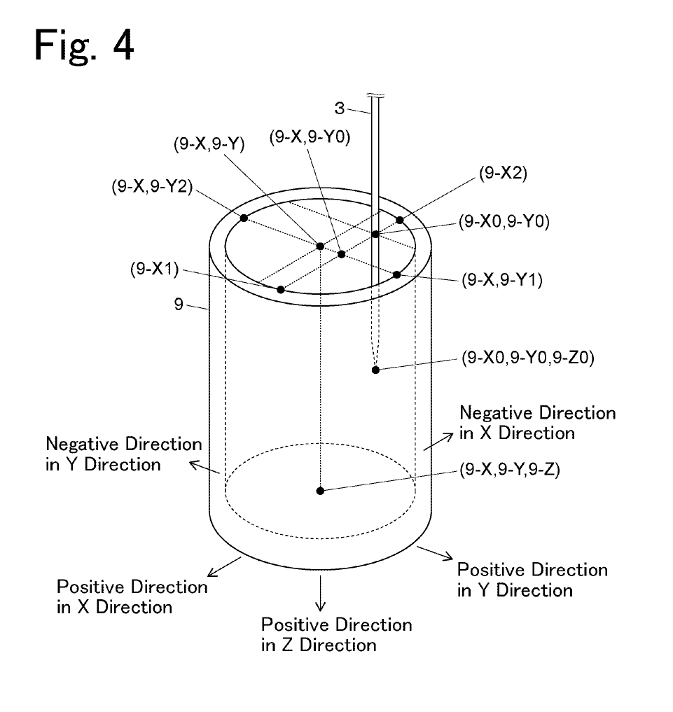

FIG. 4 is a diagram for describing an operation of a needle at the time of acquiring reference position information of the rack. Referring to FIG. 4, an operation of acquiring reference position information of the rack will be described.

(Step 1) A tip end of the needle 3 is moved, under the control of the control unit 5, to approximately the center position of the reference portion 9 on the basis of a set reference position (9-X0, 9-Y0, 9-Z0) set in advance for the reference portion 9. The tip end of the needle 3 is arranged inside the reference portion 9. The inner diameter and the depth of the reference portion 9 are designed to have values sufficiently greater than the variations in assembling at the time of manufacturing of the rack 1 so that the needle 3 at this time does not come in contact with the upper surfaces of the rack 1 and the reference portion 1.

(Step 2) The needle 3 is finely moved in a forward direction (the positive direction in the X direction) with the position (9-X0, 9-Y0, 9-Z0) as the starting point. The needle 3 is moved until contact between the reference portion 9 and the needle 3 is detected on the basis of detection information of the detection unit 15. The position of the needle 3 where contact with the reference portion 9 is detected is given as a position (9-X1). Next, the needle 3 is finely moved in a backward direction (the negative direction in the X direction) until it comes into contact with the reference portion 9. The position of the needle 3 where contact with the reference portion 9 is detected is given as a position (9-X2). The control unit 5 calculates the middle point of the position (9-X1) and the position (9-X2) as an X-direction center position (9-X). The needle 3 is moved to the X-direction center position (9-X). At this time, the needle 3 is positioned at a position (9-X, 9-Y0, 9-Z0).

(Step 3) The needle 3 is finely moved in a right direction (the positive direction in the Y direction) with the position (9-X, 9-Y0, 9-Z0) as the starting point, until it comes into contact with the reference portion 9. The position of the needle 3 where contact with the reference portion 9 is detected is given as a position (9-Y1). Next, the needle 3 is finely moved in a left direction (the negative direction in the Y direction) until it comes into contact with the reference portion 9. The position of the needle 3 where contact with the reference portion 9 is detected is given as a position (9-Y2). The control unit 5 calculates the middle point of the position (9-Y1) and the position (9-Y2) as a Y-direction center position (9-Y). The needle 3 is moved to the Y-direction center position (9-Y). At this time, the needle 3 is positioned at a position (9-X, 9-Y, 9-Z0).

(Step 4) The same operation as in step 2 described above is performed again with the position (9-X, 9-Y, 9-Z0) as the starting point. The X-direction center position (9-X) is thereby calculated again. The needle 3 is moved to the position (9-X, 9-Y, 9-Z0). Additionally, step 4 may be omitted in the case desirable position accuracy is attained with respect to the X-direction center position (9-X) in step 2 described above.

(Step 5) The same operation as in step 3 described above is performed again with the position (9-X, 9-Y, 9-Z0) obtained in step 4 described above as the starting point. The Y-direction center position (9-Y) is thereby calculated again. The needle 3 is moved to the position (9-X, 9-Y, 9-Z0). Additionally, step 5 may be omitted in the case desirable position accuracy is attained with respect to the center position (9-Y) in step 3 described above. Also, step 5 is not performed in the case step 4 described above is omitted.

(Step 6) The needle 3 is finely moved in a downward direction (the positive direction in the Z direction) with the position (9-X, 9-Y, 9-Z0) as the starting point, until it comes into contact with the reference portion 9. The tip end position (a position on the bottom surface of the reference portion 9) of the needle 3 whose contact with the reference portion 9 is detected is given as a position (9-Z). The position of the reference portion 9 (9-X, 9-Y, 9-Z) is thereby obtained.

(Step 7) The tip end of the needle 3 is moved, under the control of the control unit 5, to approximately the center position of the reference portion 11 on the basis of a set reference position (11-X0, 11-Y0, 11-Z0) set in advance for the reference portion 11. The tip end of the needle 3 is arranged inside the reference portion 11. The inner diameter and the depth of the reference portion 11 are also designed taking into account the variations in the assembling at the time of manufacturing of the rack 1, and the like, as in the case of the reference portion 9.

(Step 8) The same operations as in step 2, step 3, step 4, and step 5 described above are performed with the position (11-X0, 11-Y0, 11-Z0) as the starting point. A position (11-X, 11-Y, 9-Z0) is thereby obtained. The position (11-X) is an X-direction center position of the reference portion 11. The position (11-Y) is a Y-direction center position of the reference portion 11.

(Step 9) As in step 6 described above, the needle 3 is finely moved in a downward direction (the positive direction in the Z direction) with the position (11-X, 11-Y, 9-Z0) as the starting point, and a position (11-Z) of the bottom surface of the reference portion 9 is obtained. The position of the reference portion 11 (11-X, 11-Y, 11-Z) is thereby obtained.

(Step 10) The control unit 5 acquires position correction information for the rack 1 on the basis of the position (9-X, 9-Y, 9-Z) of the reference portion 9 and the position (11-X, 11-Y, 11-Z) of the reference portion 11.

As described above, according to the present embodiment, the reference position information of the rack may be automatically obtained. Furthermore, the position correction information may be automatically acquired on the basis of the obtained reference position information 9 and 11 of the rack 1.

According to the embodiment described above, the reference portions 9 and 11 are fixed to the rack 1, but the reference portions 9 and 11 may be attachable/detachable. Also, according to the embodiment described above, the reference portions 9 and 11 are provided at positions different from those of the sample container mounting holes 7, but the reference portions may be arranged in the sample container mounting holes 7 in an attachable/detachably manner at the time of acquisition of the reference position information of the rack 1.

Also, according to the embodiment described above, two reference portions 9 and 11, are provided to the rack 1, but the number of reference portions provided to the rack 1 may be three or more. In this case, the control unit 5 calculates an X position, a Y position, and a Z position of a reference portion for each reference portion. The accuracy of the reference position information of the rack 1 is increased as the number of the reference portions is larger. Also, in the case accuracy is not required, the number of reference portions provided to the rack 1 may be one.

In the embodiment described above, the shape of the inner wall surfaces of the reference portions 9 and 11 in horizontal cross section is circular, but the shape of the inner wall surfaces is not restricted to be circular, and any shape is allowed as long as the shape is point-symmetric. This is because, if the shape of the inner wall surface of the reference portion in horizontal cross section is point-symmetric, the X-direction center position and the Y-direction center position calculated by the automatic sample pouring device of the present invention are the centers of symmetry at all times.

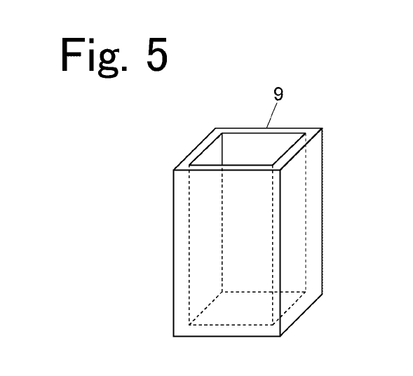

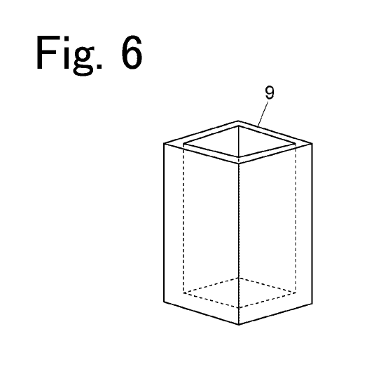

For example, the shape of the inner wall surface of the reference portion 9 in horizontal cross section may be square, as shown in FIG. 5, or may be rhombic, as shown in FIG. 6. Also, the shape of the inner wall surface of the reference portion in horizontal cross section may be an ellipse, an even-sided regular polygon such as a regular hexagon, a parallelogram such as a rectangle, or the like.

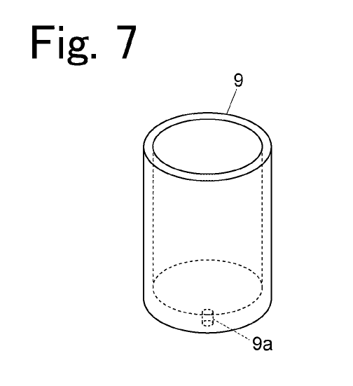

FIG. 7 is a diagram showing an example of a position of a through hole for draining liquid in a case where the through hole is provided to a reference portion arranged at the rack.

The reference portion 9 is provided with a through hole 9a for draining liquid at a position that is at a predetermined distance from the center of the bottom surface. If the through hole 9a is provided to the bottom surface of the reference portion 9, liquid which has entered inside the reference portion 9 may be easily drained. Additionally, the through hole 9a is arranged at a predetermined distance from the center of the bottom surface so that it does not interfere with the acquisition operation for the position correction information. Also, the through hole for draining liquid may be provided at a side surface of the reference portion.

The embodiment described above is only an example of the present invention, and the present invention is not restricted thereto, and various changes may be made within the scope of the present invention described in the claims.

For example, in the embodiment described above, step 2 and step 3 may be interchanged, and step 4 and step 5 may be interchanged. Also, step 6 may be performed at any timing from step 1 to step 5. In the same manner, step 9 may be performed at any timing during step 8.

Moreover, in the present invention, the detection unit is not restricted to a voltmeter, and any structure is allowed as long as contact between the reference portion and the needle may be electrically detected.

### DESCRIPTION OF REFERENCE SIGNS

1: Rack

3: Needle

5: Control unit

9, 11: Reference portion

9a: Through hole

15: Detection unit

1.-5. (canceled)

6. An automatic sample pouring device comprising:
a rack allowing mounting of a plurality of sample containers;
a sampling needle for suctioning samples contained in the sample containers;
a reference portion, arranged at a predetermined position of the rack, including a concave portion of a predetermined depth, a shape of an inner wall surface of the reference portion in horizontal cross section being point-symmetric;
a detection unit for electrically detecting contact between the reference portion and the needle; and
a control unit for controlling an operation of relatively moving the needle on a horizontal plane and in a vertical direction with respect to the rack, an operation of obtaining reference position information of the rack on the basis of detection information of the detection unit, and suctioning and pouring operations of a sample.

7. The automatic sample pouring device according to claim 6,
wherein, after moving a tip end of the needle into the reference portion, the control unit moves, until contact between the reference portion and the needle is detected on the basis of detection information of the detection unit, the needle in both positive and negative directions in an X direction on the horizontal plane, both positive and negative directions in a Y direction that is orthogonal to the X direction on the horizontal plane, and a Z direction that is the vertical direction, calculates, on the basis of a contact position of the reference portion and the needle, a position at a center of symmetry of the shape of the inner wall surface of the reference portion as an X position and a Y position of the reference portion, and takes a position of a bottom surface of the reference portion as a Z position of the reference portion, and obtains the reference position information of the rack on the basis of the X position, the Y position, and the Z position of the reference portion.

8. The automatic sample pouring device according to claim 7,
wherein the rack includes two or more of the reference portions at mutually different positions, and
wherein the control unit calculates the X position, the Y position, and the Z position of the reference portion for each of a plurality of the reference portions.

9. The automatic sample pouring device according to claim 7, wherein the control unit calculates the X position or the Y position of the reference portion by moving the needle in the X direction or the Y direction inside the reference portion, calculates, by moving the needle in the Y direction or the X direction from the X position or the Y position which has been obtained, the Y position or the X position of the reference portion, calculates again, by moving the needle again in the X direction or the Y direction from the Y position or the X position which has been obtained, the X position or the Y position of the reference portion, and calculates again, by moving the needle again in the Y direction or the X direction from the X position or the Y position which has been obtained again, the Y position or the X position of the reference portion.

10. The automatic sample pouring device according to claim 6, wherein the reference portion includes a through hole for draining liquid at a position at a predetermined distance from a center of the bottom surface, or at a side surface.

11. The automatic sample pouring device according to claim 6, wherein the reference portion is arranged in an attachable/detachable manner at a mounting position of the sample container of the rack.
